(19) United States
(12) Patent Application Publication
(10) Pub. No.: US 2022/0035039 A1
(43) Pub. Date: Feb. 3, 2022

(54) TOF CAMERA

(71) Applicant: KOITO MANUFACTURING CO., LTD., Tokyo (JP)

(72) Inventor: Koji ITABA, Shizuoka-shi (JP)

(73) Assignee: KOITO MANUFACTURING CO., LTD., Tokyo (JP)

(21) Appl. No.: 17/451,513

(22) Filed: Oct. 20, 2021

Related U.S. Application Data
(63) Continuation of application No. PCT/JP2020/017167, filed on Apr. 21, 2020.

(30) Foreign Application Priority Data
Apr. 22, 2019 (JP) 2019-081025

(51) Int. Cl. G01S 17/894; G01S 17/10; G01S 17/931; H04N 5/225; H04N 5/235

(52) U.S. Cl. CPC G01S 17/894; G01S 17/10; H04N 5/2353; H04N 5/2256; G01S 17/931

(57) ABSTRACT

A light source illuminates the FOV with pulsed illumination light having an intensity that changes with time. An image sensor is exposed to reflected light from an object in two consecutive exposures. A calculation unit generates a distance image giving consideration to the waveform of the illumination light based on the output of the image sensor acquired in the two exposures.

### BACKGROUND

### 1. Technical Field

The present disclosure relates to a ToF (Time of Flight) camera.

### 2. Description of the Related Art

In order to support autonomous driving or autonomous control of the light distribution of a headlamp, an object identification system is employed for sensing the position and the kind of an object that exists in the vicinity of a vehicle. The object identification system includes a sensor and a processing device configured to analyze the output of the sensor. As such a sensor, a desired one is selected from among a camera, LiDAR (Light Detection and Ranging, Laser Imaging Detection and Ranging), millimeter-wave radar, ultrasonic sonar, etc., giving consideration to the usage, required precision, and cost.

Typical monocular cameras are not capable of acquiring depth information. Accordingly, in a case in which there is overlap between multiple objects positioned at different distances, it is difficult to separate individual objects.

As a camera that is capable of acquiring depth information, ToF cameras are known. A ToF camera is configured to emit infrared light by means of a light-emitting device, to measure the time of flight (delay time) τ to the time point at which the reflected light returns to the image sensor, and to convert the time of flight τ into distance information in the form of an image. The distance d to an object is represented by the following Expression (1).

d=cτ/2 (1).
Here, “c” represents the speed of light.

The methods employed in ToF cameras are broadly classified into the direct and indirect methods. In the direct method, the delay time d is directly measured. In this method, a high-speed Time To Digital Converter (TDC) is employed. In a ToF camera employing the direct method, in order to provide high resolution, a high-frequency device having high-speed clock is required. Accordingly, it is difficult to employ such a method with a camera that generates an image including multiple pixels.

Accordingly, at present, ToF cameras employing the indirect method have become mainstream. As a method employed in such an indirect ToF camera, a square wave illumination method is known. FIG. 1 is a diagram for explaining the operation principle of the square wave illumination ToF camera. The ToF camera irradiates square wave illumination light to an object. The irradiated light is reflected by an object at a distance d. After the elapse of τ=2d/c, the reflected light is input to the ToF camera.

The ToF camera consecutively executes two exposures (image acquisitions) with an exposure time that is equal to the pulse width tw of the illumination light.

In the first exposure, a portion of the pulse width tw of the reflected light that corresponds to the preceding period t₁ is detected. Furthermore, in the second exposure, a portion of the pulse width tw of the reflected light that corresponds to the subsequent period t₂ is detected. The ratio of the amount of light (amount of charge Q₁) detected in the first exposure and the ratio of the amount of light (amount of charge Q₂) detected in the second exposure are proportional to the periods t₁ and t₂, respectively. Accordingly, the following relations hold true.

t₁=tw×Q₁/(Q₁+Q₂)

t₂=tw×Q₂/(Q₁+Q₂)

In a case in which the first exposure is started with a delay of td from the illumination of the illumination light, the delay time τ is represented by the following Expression (2).

τ=td+t₂=td+tw×Q₂/(Q₁+Q₂)
By substituting the delay time obtained by the Expression (2) into the Expression (1), the distance d to the object is obtained.

As a result of investigating the square wave illumination ToF camera, the present inventor has come to recognize the following problem. The square wave illumination ToF camera requires the waveform of the illumination light to be a perfect square wave. In other words, the square wave illumination ToF camera operates assuming that the illumination light is irradiated with a constant intensity in time during the pulse illumination period tw. However, it is difficult to generate such square wave illumination light with an intensity that is constant over time. In a case of supporting such a function, this leads to difficulty in designing the light source, leading to an increased cost.

### SUMMARY

The present disclosure is made in view of such a situation.

An embodiment of the present disclosure relates to a ToF camera. The ToF camera includes: a light source structured to illuminate the field of view (FOV) with pulsed illumination light having an intensity that changes with time; an image sensor structured to be exposed to reflected light from an object in the FOV in two consecutive exposures; and a calculation unit structured to generate a distance image giving consideration to the waveform of the illumination light based on the output of the image sensor acquired in the two exposures.

It is to be noted that any arbitrary combination or rearrangement of the above-described structural components and so forth is effective as and encompassed by the present embodiments. Moreover, this summary does not necessarily describe all necessary features so that the disclosure may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram for explaining the principle of the operation of a square wave illumination ToF camera;

FIG. 2 is a block diagram showing a ToF camera according to an embodiment;

FIG. 3 is a diagram for explaining the operation of the ToF camera shown in FIG. 2;

FIG. 4 is a block diagram showing a calculation unit according to an example 3;

FIGS. 5A, 5B and 5C are diagrams for explaining the calibration of the ToF camera;

FIG. 6 is a block diagram showing an object identification system provided with the ToF camera;

FIG. 7 is a diagram showing an automobile provided with the object identification system; and

FIG. 8 is a diagram showing an automotive lamp provided with the object identification system.

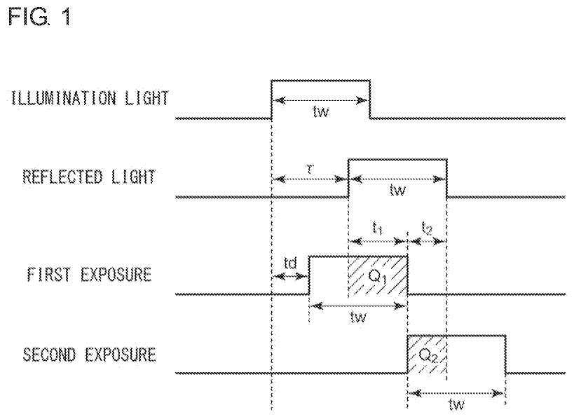

### DETAILED DESCRIPTION

### Overview of Embodiments

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

One embodiment disclosed in the present specification relates to a ToF camera. The ToF camera includes: a light source structured to irradiate pulsed illumination light having an intensity that changes with time; an image sensor arranged to be exposed to reflected light from an object in two consecutive exposures; and a calculation unit structured to generate a distance image giving consideration to the waveform of the illumination light based on the output of the image sensor acquired in the two exposures.

With this embodiment, this provides improved measurement precision even in a case in which the illumination light is not an ideal square wave. Accordingly, this allows the light source to be designed in a simple manner, thereby allowing the cost of the light source to be reduced.

In one embodiment, the calculation unit may generate the distance image using a calculation expression defined based on the waveform of the illumination light.

In one embodiment, the calculation unit may include: a distance calculation unit structured to calculate a distance assuming that the illumination light is irradiated with a constant intensity in time; and a correction unit structured to correct the distance calculated by the distance calculation unit based on correction characteristics that correspond to the waveform of the illumination light.

In one embodiment, the correction characteristics may be acquired by calibration.

### EMBODIMENTS

The preferred embodiments will now be described, which do not intend to limit the scope of the present invention but exemplify the invention. All of the features and the combinations thereof described in the embodiment are not necessarily essential to the invention.

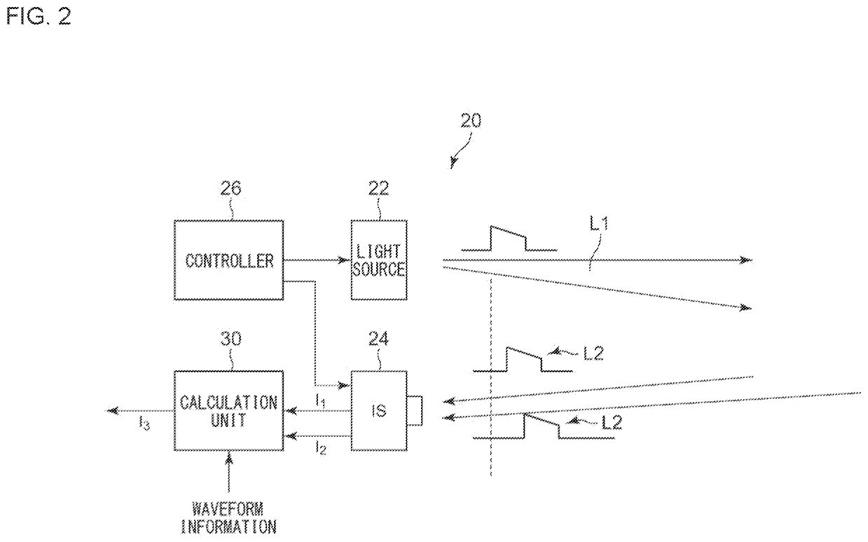

FIG. 2 is a block diagram showing a ToF camera 20 according to an embodiment. The ToF camera 20 includes a light source 22, an image sensor 24, a controller 26, and a calculation unit 30.

The light source 22 irradiates pulsed illumination light L1 with an intensity that changes with time. The image sensor 24 is configured as a sensor suitable for a ToF camera. The image sensor 24 measures reflected light L₂ reflected from an object OBJ for every two consecutive exposures. The image sensor 24 includes multiple light-receiving elements (which will also be referred to as “pixels” hereafter) in the form of an array. The image sensor 24 is configured to convert the light incident on the light-receiving elements (pixels) into the amount of charge or current for every two exposures, and to integrate the measurement values. The reflected light L₂ is incident on each pixel of the image sensor 24 with a different timing (delay time τ). The image sensor 24 generates two items of image data I₁ and I₂ that correspond to the two exposures. The pixel value of each pixel of the image data I₁ acquired in the first exposure represents the integrated value of the reflected light L₂ incident on that pixel in the first exposure (i.e., integrated amount of charge Q₁). Similarly, the pixel value of each pixel of the image data I₂ acquired in the second exposure represents the integrated value of the reflected light L₂ incident on that pixel in the second exposure (i.e., integrated amount of charge Q₂).

It should be noted that, in order to generate a single distance image I₃, a set of illumination by the light source 22 and exposures by the image sensor 24 may be repeated multiple times.

The calculation unit 30 is configured to generate the distance image I₃ giving consideration to the waveform of the illumination light L₁ based on the outputs I₁ and I₂ of the image sensor 24 acquired in the two exposures.

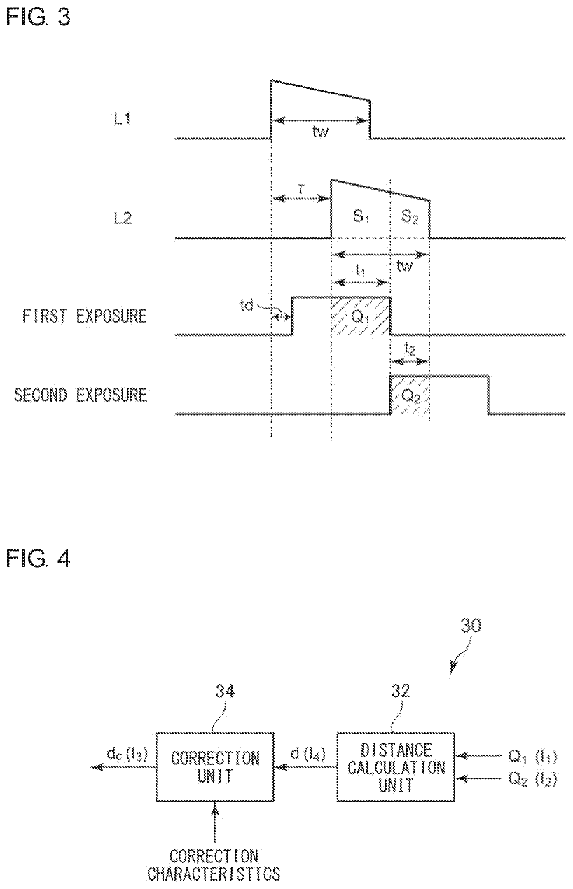

The above is the configuration of the ToF camera 20. Next, description will be made regarding the operation thereof. FIG. 3 is a diagram for explaining the operation of the ToF camera 20 shown in FIG. 2. FIG. 3 shows the operation of a single pixel. In this example, the illumination light L₁ decays with time during the illumination period tw. Description will be made assuming that there is no disturbance of the waveform due to reflection and propagation. In this case, the reflected light L₂ has the same waveform as that of the illumination light L₁. In FIG. 3, the illumination light L₁ and the reflected light L₂ have the same intensity. However, in actuality, the reflected light L₂ has an intensity that is smaller than that of the illumination light L₁.

In the first exposure, the amount of received light of the front-side portion t₁ of the reflected light L₂ is detected, and the pixel value Q₁ that represents the integrated value thereof is generated. The pixel value Q₁ represents the left-side area S₁ of the reflected light L₂.

In the second exposure, the amount of received light of the rear-side portion t₂ of the reflected light L₂ is detected, and the pixel value Q₂ that represents the integrated value thereof is generated. The pixel value Q₂ represents the right-side area S2 of the reflected light L₂.

In a case in which the illumination light L₁ has a known waveform, i.e., in a case in which the reflected light L₂ has a known waveform, and the areas S1 and S2 are known, the times t₁ and t₂ can be obtained. Subsequently, the distance d to the object that reflects the reflected light incident on the pixel can be calculated based on the Expressions (1) and (2).

The above is the operation of the ToF camera 20. With the ToF camera 20, this allows the distance to be measured with high precision even if the intensity of the illumination light L₁ changes during the illumination period tw. Furthermore, this arrangement is capable of compensating for the change of the intensity of the illumination light L₁, thereby allowing the cost of the light source 22 to be reduced.

Next, description will be made regarding the processing by the calculation unit 30 based on several examples.

### Example 1

In an example 1, the calculation unit 30 calculates the distance using an Expression defined based on the waveform of the illumination light L₁.

The intensity waveform of the illumination light L₁, i.e., the intensity waveform of the reflected light L₂, is represented by I(t). It should be noted that description will be made with the pulse rising timing as t=0. In this case, the areas S1 and S2 shown in FIG. 3 are represented by the following Expressions (3) and (4).

S₁=∫₀^{t1}I(t)dt∝Q₁ (3)

S₂=∫_{tw}^{tw}I(t)dt∝Q₂ (4)

In a case in which I(t) is known and tw is a constant, the calculation unit 30 is capable of acquiring t₁ based on the measurement results Q₁ and Q₂.

For example, let us consider a case in which the illumination light L₁ changes with a constant slope. In this case, the waveform I(t) is represented by Expression (5). It should be noted that k is a coefficient that represents the slope, and has a dimension that is the reciprocal of time.

I(t)I₀(1−kt) (5)

The Expression (2) is substituted into Expressions (3) and (4), thereby obtaining Expressions (6) and (7).

$$\begin{matrix} {Q}_{1} ∝ {\int }_{0}^{t 1} {I}_{0} ( 1 - k t ) dt = {{I}_{0} [ t - \frac{k}{2} {t}^{2} ]}_{0}^{t 1} = {I}_{0} ( {t}_{1} - \frac{k}{2} {t}_{1}^{2} ) & ( 6 ) \\ {Q}_{2} ∝ {\int }_{t 1}^{tw} {I}_{0} ( 1 - k t ) dt = {{I}_{0} [ t - \frac{k}{2} {t}^{2} ]}_{t 1}^{t w} = {I}_{0} ( ( t w - \frac{k}{2} {tw}^{2} ) - ( {t}_{1} - \frac{k}{2} {t}_{1}^{2} ) ) & ( 7 )\end{matrix}$$

Expression (8) can be obtained based on Expressions (6) and (7). Furthermore, I₀ is eliminated, thereby obtaining Expression (9), which is a quadratic equation with respect to t₁.

$$\begin{matrix}{Q}_{1} {I}_{0} ( ( t w - \frac{k}{2} t {w}^{2} ) - ( {t}_{1} - \frac{k}{2} {t}_{1}^{2} ) ) = {Q}_{2} {I}_{0} ( {t}_{1} - \frac{k}{2} {t}_{1}^{2} ) & ( 8 ) \\ \frac{k}{2} ( {Q}_{1} + {Q}_{2} ) {t}_{1}^{2} - ( {Q}_{1} + {Q}_{2} ) {t}_{1} + {Q}_{1} tw ( 1 - \frac{k}{2} tw ) = 0 & ( 9 )\end{matrix}$$

The quadratic equation is solved, thereby obtaining Expression (10).

$${t}_{1} = \frac{( {Q}_{1} + {Q}_{2} ) \pm \sqrt{{( {Q}_{1} + {Q}_{2} )}^{2} - 2 k ( {Q}_{1} + {Q}_{2} ) {Q}_{1} t w ( 1 - \frac{k}{2} t w )}}{k ( {Q}_{1} + {Q}_{2} )} = \frac{1 \pm \sqrt{1 - k ( 2 - k \cdot tw ) \cdot {twQ}_{1} / ( {Q}_{1} + {Q}_{2} )}}{k} \qquad ( 10 )$$

The calculation unit 30 is capable of calculating the time t₁ based on Expression (1). After t₁ is obtained, the delay time τ can be calculated based on the following Expression (11).

τ=td+t₂=td+tw−t₁ (11)

Subsequently, the distance d can be calculated based on Expression (3).

### Example 2

In Expression (10), the term “tw·Q₁/(Q₁+Q₂)” is nothing but the time t₁′ obtained assuming that the illumination L₁ is irradiated as a square wave without any change of intensity. Accordingly, the time t₁ obtained in a case in which the illumination light L₁ is irradiated with a change of the intensity can be obtained as a value that corrects the time t₁′ obtained assuming that there is no change in the intensity. In this case, the correction expression is represented by the following Expression (12). It should be noted that the correction Expression (12) is made assuming that t₁=0 when t₁′=0.

$${t}_{1} = \frac{1 - \sqrt{1 - k ( 2 - k \cdot tw ) \cdot {t}_{1}^{′}}}{k} \qquad ( 12 )$$

### Example 3

FIG. 4 is a block diagram showing the calculation unit 30 according to an example 3. The calculation unit 30 includes a distance calculation unit 32 and a correction unit 34. The distance calculation unit 32 receives the image data I₁ and the image data 12, and calculates the distance d to each pixel based on the pixel values Q₁ and Q₂ of the corresponding pixel. The distance d is calculated assuming that the illumination light L₁ is irradiated with a constant intensity in time. Accordingly, the distance d is calculated based on Expressions (2) and (3). The distance image 14 generated by the distance calculation unit 32 is the same as that provided according to conventional techniques. Accordingly, the distance image includes error due to waveform distortion.

The correction unit 34 corrects the distance d calculated by the distance calculation unit 32 based on correction characteristics that correspond to the waveform of the illumination light L₁, and outputs the corrected distance image I₃ including the corrected distance dc.

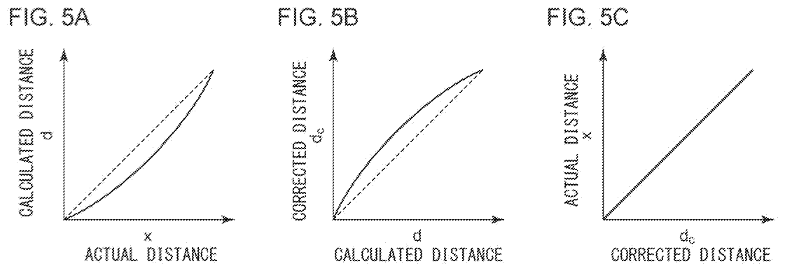

For example, the correction characteristics to be used in the correction unit 34 may be acquired by calibration. FIGS. 5A and 5B are diagrams for explaining the calibration of the ToF camera 20. In the calibration, the output d of the distance calculation unit 32 is acquired while changing the actual distance x to an object. FIG. 5A is a diagram showing the relation between the actual distance x and the calculated value d. In a case in which the illumination light L has an ideal waveform, a straight line d=x is obtained as indicated by the broken line. However, in a case in which distortion occurs in the waveform, the relation between the actual distance x and the calculated value deviates from such a straight line as indicated by the solid line. In this manner, distortion characteristics are acquired.

FIG. 5B is a diagram showing the correction characteristics that correspond to the distortion characteristics shown in FIG. 5A. In a case in which the distortion characteristics shown in FIG. 5A are represented by a function d=f(x), the correction characteristics are represented by f⁻¹(x), which is the inverse function of the function f(x).

x=f⁻¹(d)

The correction characteristics are converted into a polynomial approximation expression or a table. The polynomial approximation expression or table is stored in the correction unit 34. The correction unit 34 generates the corrected distance d_{c} that represents the corrected distance x based on the correction characteristics.

d_{c}=f⁻¹(d)

As shown in FIG. 5C, the corrected distance d_{c} matches the actual distance x.

The correction characteristics may be calculated by simulation instead of being obtained by calibration. Alternatively, in a case in which the waveform of the illumination light S1 is represented by a simple function I(t), the correction characteristics may be calculated based on the function I(t), and the correction characteristics thus obtained may be held by the correction unit 34.

### Usage

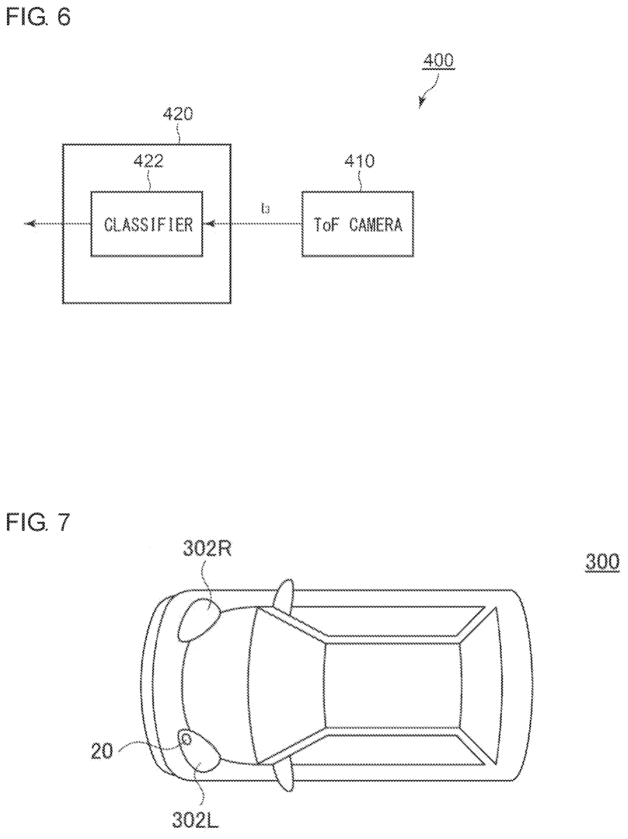

Description will be made regarding the usage of the ToF camera 20. FIG. 6 is a block diagram showing an object identification system 400 provided with a ToF camera 410. The object identification system 400 includes the ToF camera 410 and a processing device 420. The ToF camera 410 corresponds to the ToF camera 20 described above. The ToF camera 410 generates the distance image 13.

The processing device 420 is configured to be capable of identifying the position and the kind (category, class) of an object based on the distance image 13. The processing device 420 may include a classifier 422. The processing device 420 may be configured as a combination of a processor (hardware component) such as a Central Processing Unit (CPU), Micro Processing Unit (MPU), microcontroller, or the like, and a software program to be executed by the processor (hardware component). Also, the processing device 420 may be configured as a combination of multiple processors. Alternatively, the processing device 420 may be configured as a hardware component alone.

The classifier 422 may be implemented based on a prediction model generated by machine learning. The classifier 422 judges the kind (category or class) of an object included in an input image. The algorithm employed by the classifier 422 is not restricted in particular. Examples of the algorithms that can be employed include You Only Look Once (YOLO), Single Shot MultiBox Detector (SSD), Region-based Convolutional Neural Network (R-CNN), Spatial Pyramid Pooling (SPPnet), Faster R-CNN, Deconvolution-SSD (DSSD), Mask R-CNN, etc. Also, other algorithms that will be developed in the future may be employed. The processing device 420 and the calculation unit 30 of the image capture apparatus 410 may be implemented on the same processor or the same FPGA.

Also, the output of the object identification system 400 may be used for the light distribution control of the automotive lamp, Also, the output of the object identification system 400 may be transmitted to the in-vehicle ECU so as to support autonomous driving control.

FIG. 7 is a block diagram showing an automobile 300 provided with the object identification system 400. An automobile 300 is provided with headlamps 302L and 302R. A part of or the whole of the object identification system 400 is built into at least one from among the headlamps 302L and 302R. Each headlamp 302 is positioned at a frontmost end of the vehicle body, which is most advantageous as a position where the ToF camera 20 is to be installed for detecting an object in the vicinity.

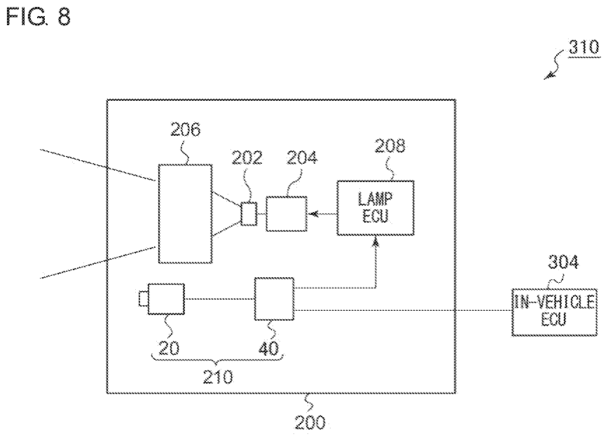

FIG. 8 is a block diagram showing an automotive lamp 200 provided with an object detection system 210. The automotive lamp 200 forms a lamp system 310 together with an in-vehicle ECU 304. The automotive lamp 200 includes a light source 202, a lighting circuit 204, and an optical system 206. Furthermore, the automotive lamp 200 includes the object detection system 210. The object detection system 210 corresponds to the object identification system 400 described above. The object detection system 210 includes the ToF camera 20 and the processing device 40.

Also, the information with respect to the object OBJ detected by the processing device 40 may be used to support the light distribution control operation of the automotive lamp 200. Specifically, a lamp ECU 208 generates a suitable light distribution pattern based on the information with respect to the kind of the object OBJ and the position thereof generated by the processing device 40. The lighting circuit 204 and the optical system 206 operate so as to provide the light distribution pattern generated by the lamp ECU 208.

Also, the information with respect to the object OBJ detected by the processing device 40 may be transmitted to the in-vehicle ECU 304. The in-vehicle ECU may support autonomous driving based on the information thus transmitted. The function of the processing device 40 for detecting an object may be implemented in the in-vehicle ECU 304.

In a case in which the light source 22 of the ToF camera 20 is built into an automotive lamp as shown in FIG. 7 or 8, the light source 22 is customized such that it fits the automotive lamp. Alternatively, the light source 22 is designed from scratch. In this case, the function for correcting the waveform distortion is implemented in the calculation unit 30 configured as a downstream stage. This arrangement is capable of compensating for the occurrence of waveform distortion in the illumination light L₁ generated by the light source 22. Accordingly, this allows the specifications required for the light source 22 to be dramatically relaxed, thereby allowing the cost thereof to be reduced.

While the preferred embodiments of the present disclosure have been described using specific terms, such description is for illustrative purposes only, and it is to be understood that changes and variations may be made without departing from the spirit or scope of the appended claims.

What is claimed is:

1. A ToF camera comprising:
a light source structured to illuminate the field of view (FOV) with pulsed illumination light having an intensity that changes with time;
an image sensor arranged to be exposed to reflected light from an object in two consecutive exposures; and
a calculation unit structured to generate a distance image giving consideration to a waveform of the illumination light based on an output of the image sensor acquired in the two exposures.

2. The ToF camera according to claim 1, wherein the calculation unit is structured to generate the distance image using a calculation expression defined based on the waveform of the illumination light.

3. The ToF camera according to claim 1, wherein the calculation unit comprises:
a distance calculation unit structured to calculate a distance assuming that the illumination light is irradiated with a constant intensity in time; and
a correction unit structured to correct the distance calculated by the distance calculation unit based on correction characteristics that correspond to the waveform of the illumination light.

4. The ToF camera according to claim 3, wherein the correction characteristics are acquired by calibration.

5. An automotive lamp comprising the ToF camera according to claim 1.

6. An automobile comprising the ToF camera according to claim 1.

7. The automobile according to claim 6, wherein the light source of the ToF camera is built into an automotive lamp.
